(19) United States
(12) Patent Application Publication
(10) Pub. No.: US 2007/0219939 A1
(43) Pub. Date: Sep. 20, 2007

(54) Portfolio Mapping of Intellectual Property

(75) Inventors: Andrew S. Van Luchene, Santa Fe, NM (US); Raymond J. Mueller, Palm Beach Gardens, FL (US); Dean Alderucci, Westport, CT (US)

Correspondence Address: GONZALES PATENT SERVICES, 4605 CONGRESS AVE. NW, ALBUQUERQUE, NM, 87114, US

(73) Assignee: Leviathan Entertainment, LLC, Santa Fe, NM (US)

(21) Appl. No.: 11/689,051

(22) Filed: Mar. 21, 2007

Related U.S. Application Data
(63) Continuation-in-part of application No. 11/627,263, filed on Jan. 25, 2007.
(63) Continuation-in-part of application No. 11/462,621, filed on Aug. 4, 2006.
(60) Provisional application No. 60/727,191, filed on Oct. 14, 2005.

(51) Int. Cl. G06F 17/30

(52) U.S. Cl. 707/1

(57) ABSTRACT

Improved methods and systems for searching, retrieving, and displaying information regarding patent applications and issued patents that may be related by inventors or assignees are described. The methods and systems may similarly incorporate and display potentially related non patent literature.

### PRIORITY CLAIM AND CROSS REFERENCE TO RELATED APPLICATIONS

The present application is a continuation in part of U.S. patent application Ser. No. 11/627,263, and a continuation in part of U.S. patent application Ser. No. 11/462,621, which claims the benefit of U.S. Provisional Patent Application No. 60/727,191.

### BACKGROUND

Protecting intellectual property through patent systems is a vital part of most country's national economies and well as the international economy. However, many known patent systems suffer from a number of disadvantages. Examples of the disadvantages of current patenting systems include: patents being issued by the patent office are of poor quality; patents take too long to be issued, compared to the demand of applicants; inventors being unable to easily search patents to locate relevant prior art; attorneys with little or no incentive to clearly identify, in a patent application they prepare, the invention being patented; and potential patent licensees lacking an easy method to determine the strength of a patent. Accordingly, it would be advantageous to provide improved methods and apparatus for examining and granting protection to intellectual property.

### BACKGROUND

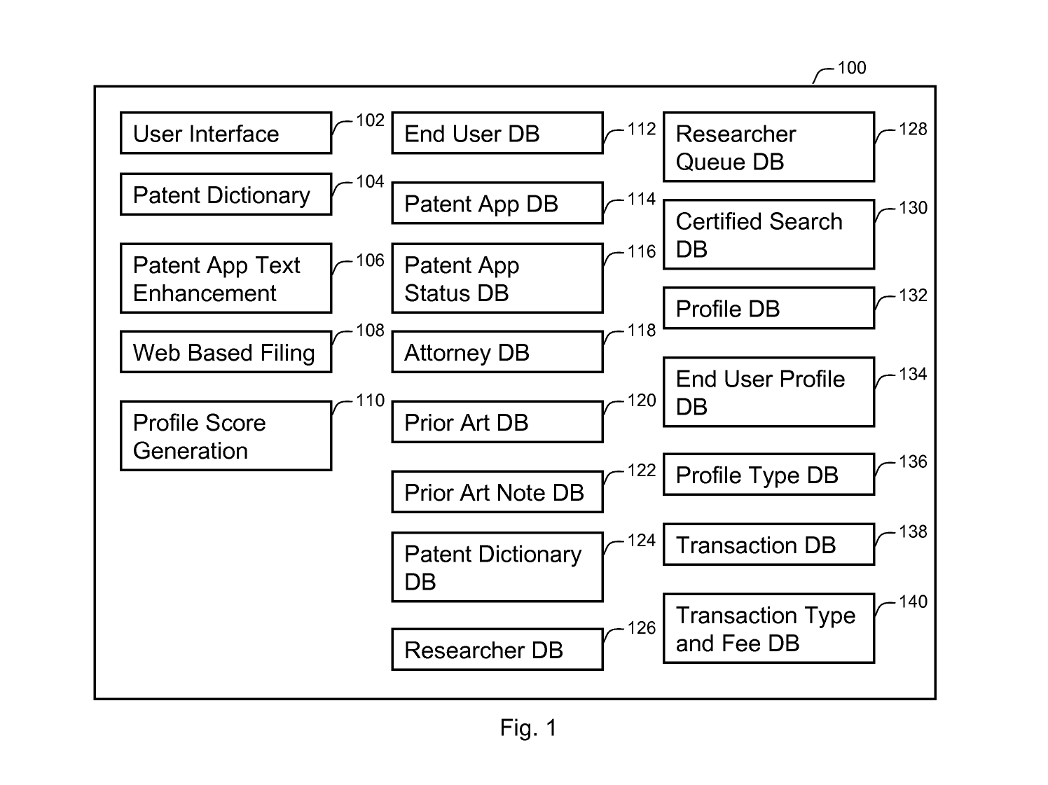

FIG. 1 is a block diagram of a system 100 according to an exemplary embodiment of the present disclosure.

### DETAILED DESCRIPTION

Definitions:

Abstract of the Invention—includes that part of a patent application that is the abstract as defined by the USPTO guidelines

Agent—includes the agent responsible for filing a patent application

Alternate Language—includes words that can be used as alternates for words in a patent application

Artificial Intelligence—includes any computer program that uses neural nets and genetic algorithms.

Assignee Name—includes the meaning defined by the USPTO guidelines

Assignee City—includes the meaning defined by the USPTO guidelines

Assignee State—includes the meaning defined by the USPTO guidelines

Assignee Country—includes the meaning defined by the USPTO guidelines

Attorney—includes the attorney responsible for drafting and/or filing a patent application.

Attorney Name—includes the meaning defined by the USPTO guidelines

Attorney Address—includes the meaning defined by the USPTO guidelines

Attorney State—includes the meaning defined by the USPTO guidelines

Attorney Country—includes the meaning defined by the USPTO guidelines

Automatic and Automatically, are used to mean that an action is performed by a electronic or mechanical system without the need for additional input, action, or prompting from a human user.

Background of the Invention—includes that part of a patent application that is background as defined by the USPTO guidelines

Claims—includes that part of a patent application that is claims as defined by the USPTO guidelines

Date Stamp—Includes an electronic, unalterable stamp on an electronic file indicated the date that the file was created or received by a computer system.

Date of Invention—includes the date a patent application has with a first time stamp

Degree of infringement—includes the statistically measured amount that a product or technical white paper infringes an issued patent application

Description of the Invention—includes that part of a patent application that is description as defined by the USPTO guidelines

Draftsperson—includes the meaning defined by the USPTO guidelines

Dollar Value—includes a dollar amount that is defined as the value of a patent license of a patent

End User—includes any user of a system including an inventor, researcher, attorney, or agent who interacts with the system, e.g., by creating, enhancing, researching, filing, prosecuting, licensing, or invalidating, a patent application. An end user may be required to be a member of a central system. An end user may further be a group of inventors, consortium, corporation, or other entity capable of interacting with the system.

Electronic notification—includes an email or other means of digitally sending a message with a date and time stamp to an electronic address.

Errors and Omissions—includes the meaning defined by the USPTO guidelines

Examiner—includes a patent examiner

Issued Patent—includes the meaning defined by the USPTO guidelines

Filing Date—shall be the time stamp of the date that a patent application was submitted to the patent office.

Filed Patent—includes a patent application that is filed with the USPTO

File Wrapper—Includes all files associated with a patent application including but not limited to: the patent application, a certified search, notes of distinguishing language, notes of rejection, notes of additional distinguishing language, record of interview, additional prior art references, and all electronic notifications associated with a patent application.

First Office Action—includes the meaning described in the USPTO guidelines.

Genetic Algorithm—includes a computer algorithm that is capable of modifying and improving itself over time.

Infringement—includes that a product or technical white paper practices the invention protected by the claims of an issued patent.

Interview—includes an electronically recorded conversation between an end user and a patent examiner.

Invention Class—includes the meaning described in the USPTO guidelines

Invention Subclass—includes the meaning described in the USPTO guidelines

Invention Figures—includes the meaning described in the USPTO guidelines

Invention Claims—includes the meaning described in the USPTO guidelines

Inventor Name—includes the meaning described in the USPTO guidelines

Inventor City—includes the meaning described in the USPTO guidelines

Inventor State—includes the meaning described in the USPTO guidelines

Inventor Country—includes the meaning described in the USPTO guidelines

Issued Patent—includes the meaning described in the USPTO guidelines

Literature Prior Art—shall be prior art for a patent application other than patents

Missing Parts—includes the meaning described in the USPTO guidelines

Non-Obviousness Score—includes a score given to a patent application by a central system that relates the obviousness of the invention disclosed by the patent application to prior art cited by the central system.

Notice of allowance—includes the meaning defined by the USPTO guidelines

Notes—includes any language added to a prior art record by an end user

Note of distinguishing language—includes notes provided by end users in response to the prior art cited in a certified search. These notes distinguish a patent application submitted by the end user over the prior art references contained in the certified search provided by the central system.

Note of additional distinguishing language—includes notes provided by end users in response to a second office action conducted by a patent examiner.

Note of rejection—shall be the notes contained in a second office action provided by a patent examiner

Novel—includes the meaning described in the USPTO guidelines

Novelty Score—includes a score given to a patent application by a central system that related the novelty of the invention disclosed in the patent application to prior art cited by the central system

Obvious—includes the meaning described in the USPTO guidelines

Office Action—includes the meaning described in the USPTO guidelines

Online Chat Room—includes any electronic correspondence medium that allows for a real time, electronic conversation between a patent examiner and an end user.

Patent Application—Includes any document created to describe and invention by an end user

Patent Application Data—Includes data contained in a patent application

Patent Application Date—includes the time stamped date that a patent application was entered into a central system

Patent Examiner—includes a person responsible for reviewing the patent application and deciding if the patent can be issued.

Patent examination queue—shall be the queue of patent applications that are assigned to a patent examiner that require office actions or reexaminations.

Patent invalidator—includes an end user who is attempting to invalidate an issued patent

Patent License—includes a legal right to use an invention disclosed in an issued patent

Patent Licensee—includes an end user who is licensing an issued patent

Patent Office—Includes the United State Patent and Trademark Office (what about the rest of the world?)

Patent Practitioner or Practitioner—includes an attorney, agent, or inventor responsible for preparation, submission, and/or prosecution of a patent application.

Patent Prior Art—includes prior art that is filed and issued patents

Patent Value score—includes a score assigned by an artificial intelligence system that demonstrates the strength of the claims of an issued patent in light of prior art.

PCT Information—includes the meaning described in the USPTO guidelines

Potential Licensee—includes an end user who may want to license an issued patent

Prior Art—includes any document with a time stamp prior to the time stamp of a patent application

Prior Art Data—Includes data that is prior art

Priority Date—includes the meaning described in the USPTO guidelines

Product—includes a created thing that can be protected by or that can infringe the claims of an issued patent

Published Prior Art—includes prior art that is available for review by the general public

Reexamination—includes a second examination of a patent after it has been issued.

Relevance Score—includes a score assigned by an end user or by a central system to a particular piece of prior art as it relates to a particular patent application.

Research Report—includes a report assemble by a researcher or a central system that contains prior art related to a patent application.

Researcher—includes a person who manually researches prior art databases to find prior art related to a patent application.

Score—includes a numerical value assigned to something as it relates to something else.

Second Office Action—includes the meaning described in the USPTO guidelines

Second examination—includes reexamination

Status Change—includes a change in status of a patent application as it moves through the patent process. Changes in status can include but are not limited submitting the application for examination, receiving a certified search for the application, placing the patent application in an examiner queue, receiving an office action for the patent application, receiving a notice of allowance for the patent application, receiving a notice of missing parts for the patent application; receiving a patent number for the patent application, and receiving an indication of interest from a potential licensee for the patent application.

Submitted Patent Application—includes a patent application that an end user submits to the central system for examination.

Subsequent Patent Application—includes an application that comes after a patent application.

Technical white paper—includes a text description of a product that describes the parts of the product and how they work together.

Time Stamp—includes an unalterable recording of the time a document was created by, entered into, or received by a system.

Title—includes the meaning described in the USPTO guidelines

Web-Based Application—includes an application that is accessible on the World Wide Web via a web browser such as Microsoft's Internet Explorer. The application will be stored on a central server and accessed via other computers.

Web-Based Form—includes an electronic form used to enter information by and end user into a web-based application

Unpublished Prior Art—includes prior art that is not available to the general public, but that can be viewed by employees of the central system.

Useful—includes the meaning described in the USPTO guidelines

Usefulness Score—includes a score given to a patent application based on its usefulness as defined by the USPTO guidelines.

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The term “consisting of” and variations thereof mean “including and limited to”, unless expressly specified otherwise.

The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus can include, e.g., a processor and those input devices and output devices that are appropriate to perform the method.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

According to one or more embodiments, the present invention provides an automated web-based patent application preparation and submission tool. In one embodiment, an end user can draft a patent application using an online tool. Once the patent application or portion thereof is created, the document can be submitted to: (i) a researcher for further research, (ii) a patent attorney for further drafting, or (iii) the patent office.

According to an embodiment, an end user may enter a description of the invention into a web-based form (e.g., an HTML form with appropriate fields, menus, check boxes or other user interface elements that permit the entry of information). The end user can enter additional information such as:
1. Title
2. Abstract
3. Description/Specification
4. Invention Class and Sub Class
5. Inventor Name
6. Inventor City
7. Inventor State
8. Inventor Country
9. Attorney or Agent
10. PCT Information
11. Date of Invention
12. Background of the invention
13. Invention FIGS.
14. Assignee Name
15. Assignee City
16. Assignee State
17. Assignee Country
18. Claims

The information submitted into the tool may be analyzed automatically and/or in real time by the system in order to perform various functions. For example, based on the information submitted, the system can recommend alternate language for sections or draft missing parts of the total patent application. For the purposes of the present disclosure, information is considered to be analyzed automatically any time it is analyzed by the system with the system having to receive additional input, such as a request or command, from the user. It will be appreciated, that computer implemented systems are subject to various operating constraints, such as server loads, processing speeds, and the like, with which those of skill in the art will be familiar and, accordingly, “real time” analysis may not necessarily be instantaneous, but is rather intended to mean that results are automatically provided to the user as soon as they are available, given the various system operating constraints.

Recommendations for alternate language or missing portions may be based on patent applications or other non-copyright protected publications describing similar inventions. For example, the system may use a genetic algorithm to determine like patent applications as the end user is entering the description of his invention. Because patent practitioners often act as their own lexicographers and coin new terminology to describe inventions, such new terminology can be shared immediately and made available to other patent practitioners. In this manner, the system can act as an ever changing virtual dictionary of language for new patent applications. An example of a genetic algorithm that can perform this function is the Semetric program offered by Engenium.

As another example, the system can perform real time prior art search based on the disclosure as the end user types words into the tool. The system could be configured to dynamically display the most relevant prior art choices based on the words and letters being typed. The prior art being displayed would then change in real time as the end user types in more words to describe the invention. It will be appreciated that such real time searching could be used for any type of searching and not just searching for prior art for inventions.

Suggestions for alternate language and missing portions or prior art or other searches need not necessarily be performed in real time, but may also or alternatively be performed after a disclosure is submitted by the end user, for example in order to receive an initial review prior to filing, or only upon the end user's request.

According to another embodiment, the system may utilize a genetic algorithm to specify a class and subclass for a patent application. The system may analyze an application in real time, or after it has been submitted, and determine the appropriate class and subclass. The genetic algorithm may or may not allow for the incorporation of classification data from previously submitted applications which are identified by the system or the end user as being similar to the current application.

According to another embodiment, the system may track and/or identify information that is missing from the patent application that is required for filing the patent application with the patent office. The end user can review missing parts for a particular patent application and fill them in as desired. The end user can also leave missing information fields open for subsequent completion, for example, by researchers and/or patent practitioners.

According to another embodiment, one or more notes could be submitted by an end user or other individual in connection with a document, including, for example, an application as it is being drafted, a submitted or filed application, a patent publication, an issued patent, a non-patent reference, an office action, a examiner or practitioner communication, a judicial or review-board decision, or the like. These notes may or may not be viewable to other users and may or may not be used by the system for any suitable purpose, including, for example, preparation or examination of the present application, preparation or examination of other applications, system maintenance, and the collection and dissemination of statistical information. Moreover, notes may or may not be submitted in response to additions, suggestions, or notes from the system or other individuals. Any suitable type of file, including, but not limited to a jpg, digital video, recording, voice message, or textual document could be added to or associated with a document as a note.

As a non-limiting example, an end user may add notes to the alternate language and missing portion suggestions provided to or by the system. These notes can be used by the genetic algorithm to generate improved alternate language and missing portion suggestions for later invention submissions by the same and/or other end users. Moreover, these notes could be readable by subsequent end users and could be used to assist in the drafting of later patent applications.

According to another embodiment, the present disclosure provides for a system in which a practitioner can elect from between multiple post-drafting processing options. The system may or may not require that the application have been drafted using a web-based drafting tool such as that described above. According to this embodiment, once an end user has completed drafting a patent application, the end-user can select whether he wants to:
1. Submit the patent application to a researcher
2. Submit the patent application to an attorney for further drafting
3. Submit the patent application to the Patent Office for filing

In an alternate embodiment, the system can recommend one of the previous three choices to an end user based on the current status of an application. According to this embodiment, the system analyzes the patent application document and compares it to previously filed patent applications. The patent application is scored and the system determines whether the application should be sent to a researcher, an attorney, or to the patent office.

If the end user elects to submit the patent application to a researcher, the system can select or suggest an optimal researcher from its database of researchers based on inventions researched by those researchers and the relevance of those inventions to the invention currently being submitted by the end user. Alternatively or additionally, the system could select or suggest a researcher based on whether a particular researcher has capacity to conduct research on the patent application. If the end user is allowed to select a researcher, a list of applicable researchers could be provided to the user by the system. The list could be sorted or sortable based on relevancy, expected timeframe for research completion, cost, location, or other factors.

As a further embodiment, if the end user is allowed to select a researcher, researchers could bid on the opportunity to research the patent application. Bids could include any number of relevant factors including but not limited to, cost for research, type of fee rate (i.e. flat fee, hourly, etc.), type and extent of results provided, and timeframe for returning results.

Moreover, the system could be configured to provide to the end user contact information for each selected or suggested researcher. The end user could then contact the selected or suggested researcher via the system interface and submit the patent application to the researcher for review. A contract can be set up, i.e., drafted and executed automatically, between the end user and the patent researcher using the system.

According to an embodiment, the researcher receives the patent application, creates a research report, and submits the research report to the end user. The research report may be submitted to the end user via the central system. According to some embodiments, the end user can review the prior art cited in the research report and rate its relevance to the invention disclosed. The relevance rankings can be used to match that researcher to subsequent patent applications. The end user can also submit notes distinguishing the application over the prior art cited and/or alter the application, such as to include distinguishing language.

According to an embodiment, the system may be configured to facilitate fee transactions between the end user and the researcher. The system may or may not impose a surcharge for facilitating the fee transactions. For example, once an application has been submitted to a researcher, the system may charge the researcher with a finder's fee. The system could also charge the end user with a researcher finder fee, or, the two parties could split a single fee. Alternatively the system could charge the researcher, who, in turn could charge the end user some, or all, of the fee amount. Alternatively or additionally, once the report has been received by the end user, a research report fee can be charged to the end user and some or all of the fee can be remitted to the researcher.

Alternatively or additionally, the system may be configured to submit the application to an automated searching program configured to produce search results using, for example, a genetic algorithm search program. A genetic algorithm search program is described, for example, previously incorporated U.S. patent application Ser. No. 11/462/621, and U.S. Provisional Patent Application Ser. No. 60/727,191.

If the end user elects to submit the patent application to an attorney (or agent) for additional drafting, the system can determine an optimal attorney from its database of attorneys. The determination may be based on any number of factors including, for example, estimated fee, past applications filed by the attorney, attorney's capacity, estimated turn-around, etc. For example, the system may be configured to identify past inventions/applications filed and prosecuted by attorneys in the database and further determine the relevance of those inventions to the invention currently being submitted by the end user.

Moreover, attorneys may be asked or required to provide the system with information regarding their fees for preparation including billing rates and fees for past applications, current availability, estimated turn-around time, contact information, etc. Accordingly, the system can select or suggest an attorney based on such information. For example, a given attorney may be selected or suggested based on whether or not the system determines that attorney has capacity to assist the inventor in enhancing the application. Once one or more attorneys are selected by the system or the end user, the system can provide the attorneys' contact information to the end user using any suitable method. According to one embodiment, the end user may receive an attorney's contact information via the web-based form.

Furthermore, the end user may be able to automatically submit the patent application to the attorney via the web-based service. The attorney may then review the application for further refinement. Changes, additions, and alterations made by the attorney may be tracked by the system. Once the attorney has completed the application, the end user may be able to log in or otherwise access the completed application via the system to order to review and approve changes made by the attorney to the application.

If the end-user is not completely satisfied with the changes made by the first attorney, the application, with or without the first attorney's changes, may be submitted to a second attorney and such process repeated until the end-user is satisfied with the application. Once final approval is received from the end-user, the patent application can be submitted to the patent office by the system.

The determination of an appropriate attorney may be made at the time the end user opts to submit the draft application to an attorney or while the end user is drafting the application. Moreover, rather than waiting until the end user believes he has “finished” the application, the end user may be able to contact the attorney via the system while drafting the application. For example, while the end user is entering the patent application data into the system, the system can determine an appropriate attorney and offer the opportunity to provide the end user with real time chat with the attorney. if the end user accepts, a chat window is opened between the end user and attorney via the central system. The end user can provide patent application data and the attorney can add and edit the data. When the session is complete, the system can charge a fee to the end user and submit a portion of that fee to the attorney. The recorded chat session is attached to the patent application file.

The system may be configured to facilitate fee transactions and contract formation between the attorney and the end-user. The system may or may not impose a surcharge for such facilitation. For example, when an end user contacts an attorney, a finder's fee can be charged to both the attorney and the end user. Furthermore the system may facilitate with the drafting and execution of a contract between the end user and attorney specifying terms and conditions so that the attorney can complete the application. The system may or may not utilize a standard contract which may or may not be modifiable by the end user and/or the attorney. Once the attorney's changes are made, the system may be configured to charge the fee specified by the contract to the end user for enhancing the patent application and submit some or all of the fee to the attorney.

Once the end user elects to submit the patent application to the patent office, the system may be configured to determine if all information fields have been completed. Once the system has determined that all information fields have been completed, the system generates the appropriate forms, and submits the patent application, along with the appropriate forms to the patent office. An electronic receipt confirmation is received from the patent office and stored by the central system as well as being transmitted to the end user. The central system charges a filing fee to the end user and remits a portion of that fee to the patent office. If all fields have not been completed, the system steps the applicant through each open field, providing examples and information about each field, its use, etc.

According to a further embodiment, the system may be configured to time stamp the patent application file as additions are made by the various parties who can access it. Moreover, the system could time and date stamp and store all files that are entered into the system and so that a record of the invention is maintained.

According to yet another embodiment, the end user may be allowed to determine whether or not an application filed with the system is to be treated as public or private data. If the filed application is be treated as public data, and thus useful as prior art against other inventions, the end user may further be allowed to identify the application as an invention registration rather than as an application. Just like a filed patent application, an invention registration can be assigned a filing date and used as prior art against later filed applications, but may not be subjected to further examination.

An end user preparing a patent application may desire to get into contact with other end users that are preparing or have prepared other similar patent applications. Accordingly, the system of the present disclosure may be configured to facilitate communication between end users who are or have worked on similar patent applications. According to this embodiment, when the system receives patent application data from an end user, the system may perform a search to find other end users that are working or have worked on similar patent applications and allow the end users to communicate with one another. Such communication may or may not be anonymous. According to one example, the system receives patent application data from an end user and then uses that patent application data to search against other end user profiles in the system. The system generates a list of end user profiles that are relevant to the patent application data and scores them based on relevance. The system then outputs the list of relevant end users to the end user submitting the patent application data. According to some embodiments, end users may be able to opt in to or out of being a member of this service.

The system may require the use of a user ID and password associated with a specific log in profile or other mechanism to protect privacy and ensure that end users are accessing only the information they are entitled to access. For example, a given user may only be given access to or receive help from applications written by himself, other members of his firm or corporation, other applications for the same inventor or assignee, or other practioners who have opted in to a program. In cases where an end user is an entity with multiple individuals who access the system, each individual may have the same or a separate log in profile.

In addition to a formal web browser interface, the system may incorporate a smaller interface, like a toolbar on a browser or a freestanding toolbar/text field that floats, and/or is hidden but present as an icon (e.g., in the bottom right hand corner in Windows XP). For example, a text field may be ever present on the screen. A user may be able to type a patent number, application number, attorney docket number, etc (along with any necessary password, confirmation number or the like), hit enter and be automatically directed to a search results screen, draft history screen, prosecution history screen, or some other desirable location.

In a further embodiment, the system may be configured to make new matter added as part of a continuation in part (CIP) or other application easily identifiable. For example, new matter could be red-lined, highlighted, or otherwise identified by altering the font or in some other recognizable manner as the application is being prepared, or at the time of submission or filing.

Furthermore, any of the processes described above, such as generation of suggested language, suggested researchers, and suggested attorneys could be performed for the new material. As a further embodiment, a new search request or automated research report could be automatically generated for the new subject matter in the CIP.

According to yet another embodiment, the system may be configured to ensure that all submissions for filing comply with any formalities requirements. For example, the system may ensure that all submitted figures fall within the current guidelines for margins size, line thickness, font size, etc. Such compliance may be determined each time a submission is made, whether an initial filing, response to an office action, filing of a continuation, divisional, continuation—in-part of the like.

According to yet another embodiment, the system could generate a clarity score for the patent application. An AI system could be trained to identify patent applications that clearly define an invention vs. applications that do not. End Users and patent examiners could provide a clarity rating for prior art. Based on the ratings assigned, an AI system can analyze newly filed patent applications and assign clarity scores to them.

The system can be built using any suitable architectural method. Examples of suitable architectural methods include, but are not necessarily limited to: 1) a simple, table based method 2) a rules based system or 3) an artificial intelligence (AI) system such as Neural Net, or Bayesian Algorithm.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components. An exemplary system 100 is shown in FIG. 1 and described below. However, it will be understood that a nearly unlimited number of variations are possible and that such description is intended to provide a non-limiting example of an implementation that could be utilized but should not be used to define the entire scope of the invention.

Accordingly, a system 100 configured to perform the various functions described above may incorporate a number of software modules configured to perform various tasks. Exemplary software modules useful for the presently-described system include:
1. User interface 102—this program allows the end user to interface with system 100.
2. Patent Words and Phrases Dictionary Program 104—this program generates like words and word phrases based on patent application text entered by an end user. These words and phrases may then be stored in a database such as Patent Words and Phrases Database 124, described below.
3. Patent Application Text Enhancement Program 106—this program identifies words and phrases in an end user's patent application and associates these words and phrases with alternative words and phrases from the patent words and phrases dictionary program 104.
4. Web Based Filing Program 108—this program allows patent applications to be created and electronically filed with the patent office.
5. Profile Score Generation Program 110—this program scores the relevance of end users to one another and to patent applications and prior art.

System 100 may further include a number of databases configured to store and associate the various types of data that are used by the system to perform the functions described above. Exemplary databases useful for the presently-described system include:

End User Database 112, which may store and associate data such as:
1. End User ID
2. End User Name
3. End User Address
4. End User Contact Info
5. End User Billing Info
6. Profile Score ID

Patent Application Database 114, which may store and associate data such as:
1. Patent Application ID Number
2. End User ID
3. Patent Application Title
4. Patent Application Abstract
5. Patent Application Description/Specification
6. Patent Application Invention Class and Sub Class
7. Patent Application Inventor Name
8. Patent Application Inventor City
9. Patent Application Inventor State
10. Patent Application Inventor Country
11. Patent Application Attorney or Agent
12. Patent Application PCT Information
13. Patent Application Date of Invention
14. Patent Application Background of the invention
15. Patent Application Invention FIGS.
16. Patent Application Assignee Name
17. Patent Application Assignee City
18. Patent Application Assignee State
19. Patent Application Assignee Country
20. Patent Application Claims
21. Patent Application Search ID
22. Patent Application Researcher
23. Patent Application Filing Date
24. Patent Application Status
25. Profile Score ID
26. Published/Unpublished Flag

Patent Application Status Database 116, which may store and associate data such as:
1. Patent Application Registered
2. Submitted to manual Search
3. Manual Search Received
4. Submitted to Attorney
5. Attorney Review Complete
6. Submitted to Formal Search
7. Formal Search Complete
8. Received Distinguishing Language Over Prior Art
9. Filed
10. Patent Examiner Review
11. Response to Examiner Review
12. Patent Abandoned
13. Final Rejection
14. Patent Issued

Attorney Database 118, which may store and associate data such as:
1. Attorney ID
2. Attorney Name
3. Attorney Address
4. Attorney Billing Info
5. Profile Score ID

Prior Art Database 120, which may store and associate data such as:
1. Prior Art ID
2. Prior Art Title
3. Prior Art Abstract
4. Prior Art Description/Specification
5. Prior Art Invention Class and Sub Class
6. Prior Art Inventor Name
7. Prior Art Inventor City
8. Prior Art Inventor State
9. Prior Art Inventor Country
10. Prior Art Attorney or Agent
11. Prior Art PCT Information
12. Prior Art Date of Invention
13. Prior Art Background of the invention
14. Prior Art Invention FIGS.
15. Prior Art Assignee Name
16. Prior Art Assignee City
17. Prior Art Assignee State
18. Prior Art Assignee Country
19. Prior Art claims
20. Profile Score ID
21. Related Prior Art Notes IDs 1-N
22. Prior Art Search Score
23. Published/Unpublished Flag

Prior Art Note Database 122, which may store and associate data such as:
1. Note ID
2. End User ID(s)
3. Patent Application ID
4. Prior Art ID(s)
5. Note Title
6. Note Description
7. Note Class
8. Note Subclass
9. Note Keyword(s) 1-N
10. Profile Score ID

Patent Words and Phrases Dictionary Database 124, which may store and associate data such as:
1. Word ID
2. Word
3. Like Words 1-N
4. Common phrases using word or like words 1-N
5. Used in Patents 1-N
6. Profile Score ID

Researcher Database 126, which may store and associate data such as:
1. Researcher ID
2. Researcher Name
3. Researcher Address
4. Researcher Billing Info
5. Profile Score ID

Researcher Queue 128, which may store and associate data such as:
1. Researcher ID
2. Patent Application ID
3. Patent Application Queue Number

Certified Search Database 130, which may store and associate data such as:
1. Search ID
2. Patent Application ID
3. Prior Art ID 1-N
4. Distinguishing Language Over Prior Art 1-N
5. Prior Art Score
6. Novelty Score
7. Usefulness Score
8. Non-obvious Score
9. Search Score
10. Clarity Score

Profile Database 132, which may store and associate data such as:
1. Profile Score ID
2. Profile Type
3. Patent Class 1-N
4. Patent Subclass 1-N

End User Profile 134, which may store and associate data such as:
1Profile Score ID
2. Patent Application(s) Class 1-N
3. Patent Application(s) Sub Class 1-N
4. Invention Keywords 1-N

Profile Type Database 136, which may store and associate data such as:
1. End User
2. Attorney
3. Researcher
4. Word
5. Patent Application
6. Prior Art

Transaction Database 138, which may store and associate data such as:
1. Transaction ID
2. Transaction Date
3. Transaction Type
4. End User ID (1-N)
5. Researcher ID (1-N)
6. Attorney ID (1-N)
7. Transaction Amount

Transaction Type and Fee Database 140, which may store and associate data such as:
1. Transaction Type
2. Transaction Fee (1-N)
3. Fee Applied to Account Type (1-N)

Accordingly, a system such as that described herein will be configured to perform various functions, such as those described above, by performing various method steps in order to accomplish one or more given tasks. Non-limiting examples of methods that may be performed by a system and the steps that the system may execute in order to perform these methods are described below:

Draft initial patent application:
1. Receive patent application information
2. Receive request for alternate language and missing part suggestions
3. Determine similar patent applications and prior art
4. Determine alternate language and missing portion suggestions based on similar applications
5. Output alternate language and missing portion suggestions
6. Receive patent application modifications based on alternate language and missing portion suggestions

Specify class and subclass:
1. Receive patent application data
2. Determine patent class and subclass based on patent application data
3. Assign class and subclass to patent application based on data received.

Enhance alternate language and missing portion suggestions based on user input
1. Output alternate language and missing portion suggestions based on patent application information
2. Receive relevance score and/or notes on alternate language and missing portion suggestions
3. Store relevance score and/or notes with patent applications and prior art for subsequent use. (Note: the scores can take into account both the prior art and the current invention being submitted, so that the relevance can be determined for later patent applications that are similar to the current application being filed.)

Submit initial application to researcher
1. Receive patent application from end user
2. Receive request to send application to researcher
3. Determine researcher based on patent application, researcher history, and researcher availability
4. Output researcher contact information
5. Receive request to submit application to researcher
6. Submit application to researcher
7. Bill end user account a researcher finders fee
8. Bill researcher account a finder's fee
9. Receive a completed research report
10. Submit report to end user
11. Bill end user account for completed report
12. Remit payment to researcher for completed report.

Rate Researcher based on Research Report Feedback
1. Submit research report to end user
2. Receive feedback for prior art cited in research report
3. Store feedback with prior art cited for subsequent search matches
4. Receive feedback for researcher
5. Store feedback with researcher record for subsequent search matches

Submit initial application to attorney for completion
1. Receive patent application from end user
2. Receive request to send application to attorney
3. Determine attorney based on patent application, attorney history, and attorney availability
4. Output attorney contact information
5. Receive request to submit application to attorney
6. Submit application to attorney
7. Bill attorney account a finder's fee
8. Bill end user account an attorney finder's fee
9. Receive completed application
10. Notify end user application has been received

Submit application to patent office
1. Receive patent application
2. Determine if there are missing parts
3. Output list of missing parts
4. If there are no missing parts, generate appropriate filing forms
5. Submit application to patent office
6. Bill end user account a filing fee
7. Remit filing fee to patent office
8. Receive notice from patent office that application was received
9. Store notice and output notice to end user.

Submit application to central system for time and date stamp
1. Receive patent application data
2. Receive indication that patent application should be submitted for a disclosure date
3. Time and Date stamp patent application data
4. Receive request to make patent application data public or private
5. Store patent application data with time stamp and public or private flag.

Find like inventors
1. Receive Patent Application Data
2. Search Patent Application Data against End User Profiles
3. Determine relevant end user profiles
4. Score relevant end user profiles
5. Output end user profiles in order of their scores

According to yet another embodiment, the present disclosure provides methods to conduct portfolio mapping of patent applications. According to one aspect of this embodiment, a web-based patent application drafting system, such as that described above allows an end user to map prior art references according to data in the documents such as inventor and assignee information.

In one embodiment, an inventor map is generated from an inventor name in a patent application. The name is a hyperlink in the digital patent application document. The system generates a map of all inventions associated with the inventor, whether the inventor is named as an inventor on a patent application or a patent application he is named on is sited as prior art for a patent application.

Alternatively, the end user could right click a patent number and select the option to map inventors on the patent application from a pop up menu. Tolerance levels could be set which include or ignore the middle initial, address, etc of an inventor.

This method of searching can be conducted on a single inventor name or on a group of inventor names. A patent map could be generated that shows applications that all inventors in a group are listed on, some inventors in a group are listed on, and one inventor of a group is listed on. Certain inventor names could also be excluded from the list.

In another embodiment, an inventor map is generated from an assignee name. The system generates a map of all inventors related to a particular assignee along with other inventions that the inventors appear on, either as inventors or as prior art. The list can be sorted, for example, by alphabetical order of first name, alphabetical order of last name, and/or number of patents.

According to an embodiment, each inventor name listed in a document is a link. Clicking on the inventor name launches a search for all patents and/or applications of that inventor (whether or not of the search assignee).

According to an embodiment, there may be an inventor name window or frame which includes additional buttons for performing functions on the set of inventor names. For example, one function could be “Find Unassigned Only” which finds patents/applications of those inventors but that are NOT assigned to the assignee just searched. There could be a “Find All” which finds all patents/applications of those inventors, both those which are assigned to the assignee and those which are not.

Prior Art for a patent application can also be mapped in a similar manner.

The system can be built utilizing three different architectural methods: 1) a simple, table based method 2) a rules based system or 3) an artificial intelligence (AI) system such as Neural Net, or Bayesian Algorithm.

Accordingly, the presently described system may incorporate one or more programs or modules configured to perform the various functions described herein. These programs may be housed on one or more servers, including system or client servers. As a non-limiting example, the system may include the following programs housed on the following server:

Central Server
1. Patent Mapping Program

The system may further include one or more databases configured to collect and associate various data. Non-limiting examples of databases that would be suitable in the presently described system include:

Patent Application Database
1. Application ID
2. Application Data
3. Application Inventors 1-N
4. End User ID
5. Assignee ID
6. Application Class
7. Application Subclass

Prior Art Database
1. Prior Art ID
2. Prior Art Data

Patent Map Database
1. Map ID
2. Map Type
3. Map Descriptor
4. Parent Application ID
5. Child Application ID 1-N
6. Child Prior Art ID 1-N

Moreover, the system may be configured to perform various method steps such as, but not limited to:
1. Generate an inventor map from an inventor name
2. Receive an inventor name
3. Submit request to map inventors
4. Generate inventor map including inventor names and the number of patents they appear on based on assignee name
5. Output inventor map

Generate an inventor map from an assignee name
1. Receive an assignee name
2. Submit request to map inventors
3. Generate inventor map including inventor names and the number of patents they appear on based on assignee name
4. Output inventor map

The invention is described with reference to several embodiments. However, the invention is not limited to the embodiments disclosed, and those of ordinary skill in the art will recognize that the invention is readily applicable to many other diverse embodiments and applications. Accordingly, the subject matter of the present disclosure includes all novel and nonobvious combinations and subcombinations of the various systems, methods and configurations, and other features, functions, and/or properties disclosed herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A method comprising:
providing a database comprising patent applications and issued patents in electronic form; wherein each patent application and issued patent is associated with at least one of an inventor, owner, or assignee;
receiving a request from a user to display a patent application or issued patent;
displaying the requested patent application or issued patent;
providing, in the displayed patent application or issued patent, a hyperlink which, when selected by the user, displays a list of other patent applications or issued patents in the database that are associated with the inventor, owner, or assignee associated with the displayed patent application or issued patent.

2. The method of claim 1 wherein the method further comprises:
receiving a patent application via a web-based patent application drafting and submission system;
identifying an inventor, owner, or assignee associated with the patent application; and
automatically adding the received patent application to the database.

3. The method of claim 1 further comprising displaying the number of patent applications or issued patents in the database that are associated with the inventor, owner, or assignee associated with the displayed patent application or issued patent.

4. The method of claim 1 wherein the displayed patent application or issued patent includes an inventor's name and the inventor's name serves as the hyperlink.

5. The method of claim 4 wherein when the hyperlinked inventor name is selected the method comprises:
determining other patent applications or issued patents in the database that name the inventor; and
determining the assignees of the patent applications or issued patents that name the inventor.

6. The method of claim 5 further comprising displaying to the user the list of the assignees.

7. The method of claim 5 further comprising displaying to the user a list of patent applications and/or published patents assigned to the assignees.

8. The method of claim 6 wherein each assignee name in the list acts as a hyperlink to a list of patent applications and/or published patents assigned to that assignee.

9. The method of claim 1 wherein the displayed patent application or issued patent includes an assignee name and the assignee name serves as the hyperlink.

10. The method of claim 9 wherein, when the hyperlinked assignee name is selected, the method comprises:
determining the inventors of the displayed patent application or issued patent; and
determining a list of inventors identified as inventors on patent applications or issued patents in the database that are assigned to the same assignee.

11. The method of claim 10 further comprising displaying to the user the list of inventors.

12. The method of claim 11 further comprising displaying to the user a list of patent applications and/or issued patents that name at least one of the inventors on the list.

13. The method of claim 10 wherein each inventor name in the list acts as a hyperlink to a list of patent applications and/or published patent naming that inventor.

14. The method of claim 1 wherein the database further comprises non-patent literature in electronic form.

15. The method of claim 14 wherein each piece of non-patent literature is associated with at least one of an author, institution, or corporate entity.

16. The method of claim 15 further comprising providing, in the displayed patent application or issued patent, a hyperlink which, when selected by the user, displays a list of non-patent literature where the author, institution, or corporate entity of the non-patent literature is the inventor, owner, or assignee associated with the displayed patent application or issued patent.

17. A searchable patent database comprising:
a set of patent applications and issued patents in electronic form; and
a user interface whereby a user can request that a given patent application or issued patent be displayed;
wherein, each patent application and issued patent includes a hyperlink associated with at least one of an inventor name, an assignee name, or an owner name;
and wherein, each hyperlink, when selected, displays to the user a set of patent applications and/or issued patents that are associated with an inventor name, assignee name, or owner name that is the same as the inventor name, assignee name, or owner name on the displayed patent application or issued patent.

18. The searchable patent database of claim 14 wherein the searchable patent database further comprises non-patent literature in electronic form.

19. The searchable patent database of claim 18 wherein each piece of non-patent literature is associated with at least one of an author; a institution, or a corporate entity.

20. The searchable patent database of claim 19 wherein each hyperlink, when selected, displays to the user non-patent literature that is associated with an author, institution, corporate entity that is the inventor, assignee or owner of the displayed patent application of issued patent.
